(19) United States
(12) Patent Application Publication
(10) Pub. No.: US 2024/0072267 A1
(43) Pub. Date: Feb. 29, 2024

(54) SEPARATOR ASSEMBLY FOR FUEL CELL AND FUEL CELL STACK INCLUDING THE SAME

(71) Applicants: Hyundai Motor Company, Seoul (KR); Kia Corporation, Seoul (KR)

(72) Inventors: Jin Hyeok Yoo, Yongin-Si (KR); Sun Do Shin, Yongin-Si (KR); Kyeong Min Kim, Namyangju-Si (KR); Byung Gun Song, Gwangju-Si (KR)

(73) Assignees: Hyundai Motor Company, Seoul (KR); Kia Corporation, Seoul (KR)

(21) Appl. No.: 18/135,446

(22) Filed: Apr. 17, 2023

(30) Foreign Application Priority Data
Aug. 31, 2022 (KR) 10-2022-0109979

(51) Int. Cl. H01M 8/0247; H01M 8/0267

(52) U.S. Cl. CPC H01M 8/0247; H01M 8/0267; H01M 2008/1095

(57) ABSTRACT

A separator assembly for a fuel cell and a fuel cell stack including the same, is uniformly capable of forming a surface pressure of a region where a reaction gas flows when a stack is stacked by adjusting a height and shape of a gasket line for each region in which the reaction gas flows.

### CROSS REFERENCE TO RELATED APPLICATION

The present application claims priority of Korean Patent Application No. 10-2022-0109979 filed on Aug. 31, 2022, the entire contents of which is incorporated herein for all purposes by this reference.

### BACKGROUND OF THE PRESENT DISCLOSURE

### Field of the Present Disclosure

The present disclosure is related to a separator assembly for a fuel cell and a fuel cell stack including the same, and more specifically, the separator assembly for a fuel cell and the fuel cell stack including the same can uniformly form a surface pressure of a region where a reaction gas flows when a stack is stacked by adjusting a height and shape of a gasket line for each region in which the reaction gas flows.

### Description of Related Art

A fuel cell is a kind of power generation device that electrochemically reacts a chemical energy of fuel in a stack and converts the chemical energy into electrical energy and may be used to provide power of a small electronic product such as portable devices, as well as to provide driving power for industrial, home and vehicles. Recently, usage region thereof is gradually expanding as a high-efficiency clean energy source.

FIG. 1 is a view illustrating a configuration of a general fuel cell stack.

As illustrated in FIG. 1, a membrane-electrode assembly (MEA) is located at the innermost portion of a unit cell constituting a general fuel cell stack. A membrane-electrode assembly 10 consists of a polymer electrolyte membrane 11 capable of transferring a proton and a catalyst layer coated to allow hydrogen and oxygen to react on both sides of an electrolyte membrane, that is, an anode 12 and a cathode 13.

Furthermore, a pair of gas diffusion layers 20 (GDL) are stacked on outside of the membrane-electrode assembly 10, that is, the anode 12 and the cathode 13 are located, and a separator assembly 30, in which a flow path is formed to supply fuel and discharge water generated by a reaction, is located with a gasket line 40 interposed therebetween in outside of a gas diffusion layer 20.

At the present time, the separator assembly 30 is joined by an anode separator 31 disposed in the anode and a cathode separator 32 disposed in the cathode facing each other.

Meanwhile, a fuel cell stack is formed by stacking a plurality of unit cells, and an end plate 50 for supporting and fixing each of the components is coupled to an outermost side of a stacked unit cells.

At the present time, the anode separator 31 disposed in any one of unit cell is placed and stacked to face the cathode separator 32 of another unit cell disposed adjacent to the unit cell.

Accordingly, to smoothly perform a stacking process of the unit cell and to maintain the alignment of each unit cell, the unit cell is constructed using the separator assembly 30 which integrates the cathode separator 32 and the anode separator 31 of adjacent unit cells disposed to face each other.

At the present time, the anode separator 31 and the cathode separator 32 constituting the separator assembly 30 are bonded and integrated, and a manifold communicates with each other, and a reaction region is configured in similar shapes to place at the same position.

Meanwhile, in the separator assembly 30, a plurality of manifolds and the reaction region are spaces in which reaction gas or cooling water inflows and outflows, and an airtight line is formed by the gasket line 40 along circumference thereof for confidentiality.

In general, the gasket line 40 is formed by injecting a rubber gasket to the surface of at least one of the anode separator 31 and the cathode separator 32 at a predetermined thickness.

For example, a gasket may not be formed in the anode separator 31, but the gasket line 40 may be formed in various shapes on a cathode reaction surface and a cathode cooling surface of the cathode separator 32. Of course, the gasket may not be formed in the cathode separator 32, and the gasket line 40 may be formed in various shapes on an anode reaction surface and an anode cooling surface of the anode separator 31.

FIG. 2A is a view illustrating an anode separator constituting a general fuel cell stack, and FIG. 2B is a view illustrating the cathode reaction surface of a cathode separator constituting a general fuel cell stack, and FIG. 2C is a view illustrating a cathode cooling surface of the cathode separator constituting a general fuel cell stack.

As illustrated in FIG. 2A, the anode separator 31 which constitutes the general fuel cell stack, has an anode reaction region 1a which forms a flow path through which hydrogen flows in the central region, and a plurality of manifolds 1b are formed in both regions of the anode reaction region 1a. At the instant time, six of manifolds 1b are provided, and hydrogen, air, or cooling water is introduced or discharged, respectively.

A hydrogen inflow flow path 31a is formed to introduce flowing hydrogen into the anode reaction region 1a through a hydrogen inflow manifold 1b′ between the hydrogen inflow manifold 1b′ which hydrogen inflow and the anode reaction region 1a among the plurality of manifolds 1b formed in the anode separator 31.

At the present time, a plurality of hydrogen inflow flow paths 31a are formed to protrude and penetrate in the direction of the anode reaction surface. Furthermore, a plurality of support protrusions 31b formed to protrude in the direction of the anode reaction surface may be formed at a position spaced apart by predetermined interval from a hydrogen flow path 31a. Therefore, when a fuel cell stack is stacked, a frame (hereinafter referred to as “sub-gasket 10”) surrounding and supporting the membrane-electrode assembly 10 is in contact with a plurality of hydrogen inflow flow paths 31a protruding from the anode separator 31 and the support protrusion 31b.

Furthermore, a gasket forming an airtight line is not formed in the anode separator 31.

Meanwhile, as illustrated in FIGS. 2B and 2C, the cathode separator 32 constituting a general fuel cell stack also forms a cathode reaction region 2a in which a flow path through which air flows is formed in the central region, and a plurality of manifolds 2b are formed in both sides of the cathode reaction region 2a. At the instant time, six of manifolds 2b are provided like the anode separator 31, and hydrogen, air, or cooling water is introduced or discharged, respectively.

An air inflow flow path 32a is formed between an air inflow manifold 2b′ through which air flows and the cathode reaction region 2a among the plurality of manifolds 2b formed in the cathode separator 32 to inflow flowing air into the cathode reaction region 2a through the air inflow manifold 2b′.

Meanwhile, various types of the gasket line 40 are formed in the cathode separator 32 to maintain confidentiality while forming a flow path through which hydrogen, air, or cooling water flows.

For example, as illustrated in FIG. 2B, the cathode reaction surface of the cathode separator 32 is formed with a reaction surface gasket line 40R, which contacts with the anode separator or the sub-gasket while securing a path through which air flows and blocking a path through which cooling water flows.

At the present time, the reaction surface gasket line 40R is divided into an external gasket line 41 where the anode separator 31 contacts while surrounding a plurality of manifolds 2b and the cathode reaction region 2a, and an internal gasket line 42 where the sub-gasket 10′ contacts while surrounding the cathode reaction region 2a and a path through which air is introduced is secured.

Furthermore, as illustrated in FIG. 2C, a cooling surface gasket line 40C is formed on the cathode cooling surface of the cathode separator 32 to be in contact with the anode separator 31 while securing a path through which cooling water flows and blocking a path through which air flows.

Thus, the sub-gasket 10′ is stacked between the anode separator 31 and the cathode separator 32 to form a unit cell.

Furthermore, FIG. 3 is a view illustrating a unit cell constituting a general fuel cell stack.

As illustrated in FIG. 3, the unit cell constituting a general fuel cell stack is stacked with the sub-gasket 10′ between the anode reaction surface of the anode separator 31 and the cathode reaction surface of the cathode separator 32. At the instant time, both sides of the sub-gasket 10′ are disposed in the anode reaction region 1a of the anode separator 31 and the cathode reaction region 2a of the cathode separator 32, respectively.

Meanwhile, a cathode cooling surface of the cathode separator 32 is stacked by being disposed to face an anode cooling surface of the anode separator 31 constituting the unit cell disposed adjacent thereto.

Accordingly, a surface pressure is formed between the anode separator 31 and the cathode separator 32 by the reaction surface gasket line 40R and the cooling surface gasket line 40C formed on the cathode separator 32. At the instant time, due to a plurality of support protrusions 31b formed on the anode separator 31, the surface pressure around the anode separator 31 and the cathode separator 32 was unevenly formed or airtightness was not maintained.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a separator assembly for a fuel cell and a fuel cell stack including the same, which may uniformly form a surface pressure of a region where a reaction gas flows when a stack is stacked by adjusting a height and shape of a gasket line for each region in which the reaction gas flows.

The technical objects to be achieved by the present disclosure are not limited to the above-mentioned technical objects, and the other technical objects not mentioned may be clearly by those skilled in the art from the present disclosure.

A fuel cell separator assembly according to an exemplary embodiment of the present disclosure is a fuel cell separator assembly in which a pair of opposing separators are stacked with a sub-gasket surrounding and supporting a membrane-electrode assembly (MEA), and includes a first separator formed with, a first reaction surface disposed to face the membrane-electrode assembly on a first side thereof and flowed with a first reaction gas, a first cooling surface to be cooled in a second side thereof, and a forming unit which a plurality of support protrusions are formed at predetermined interval therebetween to protrude toward the sub-gasket; and a second separator formed with, a second cooling surface disposed on one side to face the first cooling surface of the first separator to be cooled, a second reaction surface through which a second reaction gas flows to the other surface, a reaction surface gasket line for airtightness of the first reaction surface or the sub-gasket of the first separator with the second reaction surface, and a cooling surface gasket line forming an airtight line between the first cooling surface of the first separator and the second cooling surface. Among reaction surface gasket lines formed in the second separator, a low region corresponding to a region where the forming unit of the first separator is formed is lower than a high region corresponding to a region where the forming unit is not formed.

One surface of the sub-gasket is in contact with a forming unit of the first separator, and the other surface of the sub-gasket is in contact with the low region of the reaction surface gasket line, in the region where the forming unit of the first separator is formed, and an edge region of the sub-gasket is bent by a height difference between the low region and the high region of the reaction surface gasket line, so that a first surface of the sub-gasket is in contact with the first reaction surface of the first separator and a second surface of the sub-gasket is in contact with the high region of the reaction surface gasket.

Among reaction surface gasket lines formed in the second separator, a height of the low region is lower than a height of the high region by a height of the support protrusion.

Among cooling surface gasket lines formed on the second separator, a width of the region where the forming unit is formed is wider than a width of the support protrusion.

Among the cooling surface gasket lines formed on the second separator, a protrusion unit protruding toward the first cooling surface of the first separator is formed along an edge portion of the forming unit formed with the support protrusion in a region where the forming unit is formed.

The protrusion unit is formed so that the support protrusion is in contact with an unformed region in a forming unit.

The protrusion unit is formed in a shape of line along a periphery of the support protrusion in the forming unit or is formed in a shape of a dot at a predetermined interval.

Among low region of the reaction surface gasket lines formed in the second separator, only a region that contacts with the support protrusion through the sub-gasket is in contact with the sub-gasket.

Among low region of the reaction surface gasket lines formed on the second separator, a region not in contact with the support protrusion through the sub-gasket is formed to have a height lower than the support protrusion through the sub-gasket.

A surface of the low region of the reaction surface gasket line formed on the second separator is formed in an uneven shape in which embossed units and engraved units are alternately formed, and the embossed units of the low region are formed in a region in contact with the support protrusion through the sub-gasket, and the engraved units of the low region are formed in a region that does not contact with the support protrusion through the sub-gasket.

A gasket line for confidentiality is not formed in the first reaction surface and the first cooling surface of the first separator.

The first reaction region which a flow path through which the first reaction gas flows is formed is formed in a central region of the first separator, a plurality of manifolds are formed in first and second regions of the first reaction region, and any one of the manifolds is a reaction gas inflow manifold which the first reaction gas flow between the reaction gas inflow manifold and the first reaction region, a plurality of first reaction gas inflow flow paths protruding and penetrating in a direction of the first reaction surface are formed between the reaction gas inflow manifold and the first reaction region so that the first reaction gas introduced through the reaction gas inflow manifold flows from the first cooling surface to the first reaction surface, and the forming unit is formed to be spaced from the first reaction gas inflow flow path by a predetermined interval in a first reaction region direction.

In the first separator, the first reaction gas inflow flow path is spaced apart by a predetermined interval along a width direction of the first separator, and a plurality of first reaction gas inflow flow paths are formed in parallel in a flow direction and a vertical direction of the first reaction gas, and the plurality of support protrusions are spaced apart along the width direction of the first separator, and are formed on a line parallel to a line in which the first reaction gas inflow flow path is formed.

Meanwhile, a fuel cell stack according to an exemplary embodiment of the present disclosure includes: a sub-gasket surrounding and supporting a membrane-electrode assembly; a pair of gas diffusion layers (GDL); and a plurality of unit cells including of the first separator and the second separator. The first separator and the second separator facing each other in adjacent unit cells are bonded and integrated. The first separator is disposed on a first surface thereof to face the membrane-electrode assembly to form a first reaction surface through which a first reaction gas flows, to form a first cooling surface through which the cooling is cooled on a second surface thereof, and to form a forming unit in which a plurality of support protrusions are formed at predetermined interval therebetween to protrude toward the sub-gasket. The second separator is disposed on a first surface thereof to face the first cooling surface of the first separator to form a second cooling surface, a second reaction surface through which a second reaction gas flows on a second surface thereof, and in the second reaction surface, the reaction surface gasket line for airtightness is formed between the first reaction surface or the sub-gasket of the first separator, and the cooling surface gasket line is formed on the second cooling surface to form an airtight line between the first cooling surface of the first separator. Among reaction surface gasket lines formed in the second separator, a low region corresponding to a region where the forming unit of the first separator is formed is lower than a high region corresponding to a region where the forming unit is not formed.

A surface of the sub-gasket contacts with the forming unit in the region where the forming unit of the first separator is formed, and a second surface thereof contacts with the low region of the reaction surface gasket line. The sub-gasket is bent by a height difference between a low region and a high region of the reaction surface gasket line in an edge region thereof, so that a first surface thereof contacts with the first reaction surface of the first separator and a second surface contacts thereof with the high region of the reaction surface gasket line.

The gasket line for confidentiality is not formed in the first reaction surface and the first cooling surface of the first separator.

According to an exemplary embodiment of the present disclosure, by adjusting a height of a gasket line formed in a cathode separator for each region, it is expected that a surface pressure of a cooling surface uniformly may maintain with an anode separator when a stack is stacked.

Furthermore, by adjusting a shape of the gasket line formed on the cathode separator, it is expected that a forming unit formed on an anode separator uniformly may maintain the surface pressure when a stack is stacked.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view illustrating a configuration of a general fuel cell stack.

FIG. 2A is a view illustrating an anode separator constituting a general fuel cell stack.

FIG. 2B is a view illustrating a cathode reaction surface of a cathode separator constituting a general fuel cell stack.

FIG. 2C is a view illustrating a cathode cooling surface of the cathode separator constituting a general fuel cell stack.

FIG. 3 is a view illustrating a unit cell constituting a general fuel cell stack.

FIG. 4 is a view exemplarily illustrating an important portion of a second cooling surface of a second separator forming the fuel cell stack according to an exemplary embodiment of the present disclosure.

FIG. 5A, FIG. 5B, and FIG. 5C are views exemplarily illustrating a cross-section of a first reaction gas inflow region in the fuel cell stack according to an exemplary embodiment of the present disclosure.

FIG. 6 is a view exemplarily illustrating a cross-section of the first reaction gas inflow region in the fuel cell stack according to an exemplary embodiment of the present disclosure.

FIG. 7 is a view exemplarily illustrating a cross-section of the first reaction gas inflow region in the fuel cell stack according to a modified example of the present disclosure.

FIG. 8 is a view exemplarily illustrating a cross section of the first reaction gas inflow region in the fuel cell stack according to another modified example of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION OF THE PRESENT DISCLOSURE

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments included in the present specification will be described in detail with reference to the accompanying drawings. However, regardless of the reference character, the same or similar constituent elements shall be provided the same reference number and the redundant descriptions thereof shall be omitted.

The suffix “module” and “unit” for the constituent elements used in the description below are provided or mixed only in consideration of the ease of writing the specification, and do not have any distinctive meaning or role in itself each other.

In describing the embodiments of the present specification, when a specific description of related art is deemed to obscure the subject matter of the exemplary embodiments of the present specification, the detailed description will be omitted. Furthermore, the accompanying drawings are intended to facilitate the understanding of the exemplary embodiments set forth in the present specification, and the technical idea of the present specification is not limited by the accompanying drawings. All alterations, equivalents, and substitutes that are included within the technical idea of the present disclosure should be understood as falling within the scope of the present disclosure.

The ordinal number terms first, second, and the like may be used to describe various constituent elements but may not limit these constituent elements. These terms are only used to distinguish one constituent element from another element.

It should be understood that a constituent element, when referred to as being “connected to” or “coupled to” another constituent element, may be directly connected or directly coupled to another constituent element or may be coupled or connected to another constituent element with a third constituent element disposed therebetween. In contrast, it should be understood that a constituent element, when referred to as being “directly coupled to” or “directly connected to” another constituent element, is coupled or connected to another constituent element without a third constituent element therebetween.

A noun in singular form has the same meaning as nouns when used in plural form, unless it has a different meaning in context.

It should be understood that, throughout the present specification, the term “include”, “have” or the like is intended to indicate that a feature, a number, a step, an operation, a constituent element, a component, or a combination thereof is present, without precluding the possibility that one or more other features, numbers, steps, operations, constituent elements, components, or a combination thereof will be present or added.

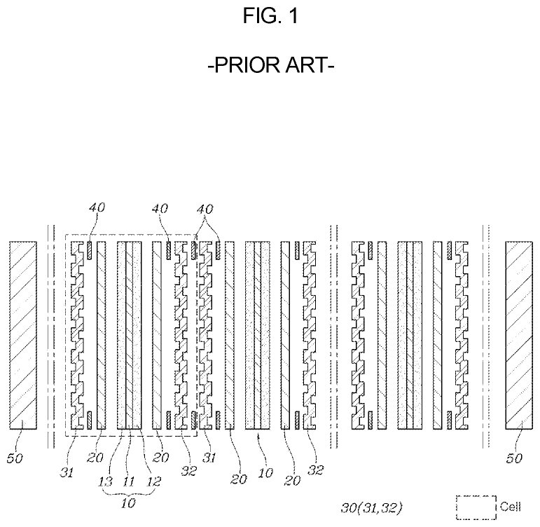

A fuel cell stack according to an exemplary embodiment of the present disclosure improves a height and shape of a gasket line formed on a separator for each region so that a surface pressure is uniformly maintained around a forming unit formed on the separator when a stack is stacked while maintaining a general fuel cell stack configuration illustrated in FIG. 1.

As illustrated in FIG. 1, the fuel cell stack according to an exemplary embodiment of the present disclosure includes a membrane-electrode assembly 10, a pair of the gas diffusion layers 20, and a pair of separators 31 and 32, forms a unit and is configured by connecting a plurality of unit cells in series. The pair of separators 31 and 32 will be described by being divided into a first separator 31 and a second separator 32. Herein, the first separator 31 may be an anode separator, and the second separator 32 may be a cathode separator. Of course, the cathode separator may be applied as the first separator 31, and the anode separator may be applied as the second separator 32.

Meanwhile, the first separator 31 configured in one unit cell is disposed to face the second separator 32 configured in the adjacent unit cell, and in the present exemplary embodiment of the present disclosure, a separator assembly is configured by stacking the first separator 31 and the second separator 32 facing each other. At the instant time, a frame which is surrounding and supporting the membrane-electrode assembly 10 (hereinafter referred to as “sub-gasket 10′”) is provided around the membrane-electrode assembly 10.

Therefore, redundant descriptions of the fuel cell stack and the unit cell will be omitted in the following description.

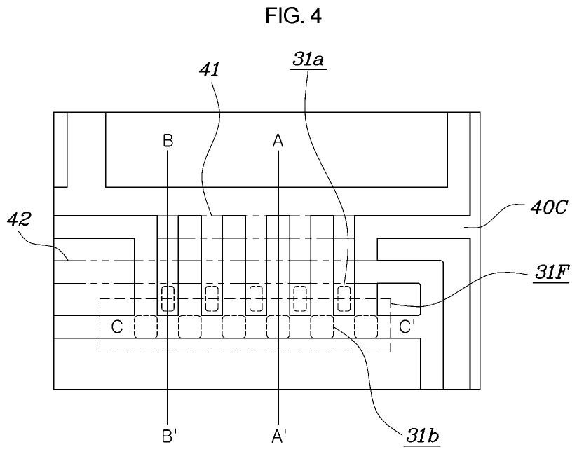

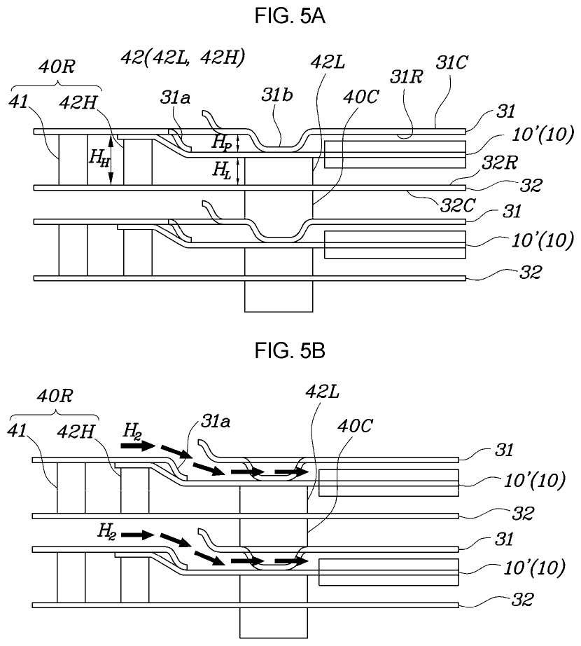

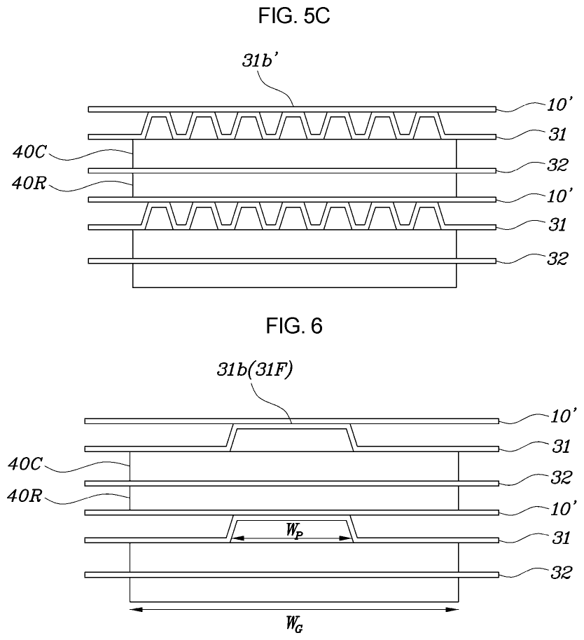

FIG. 4 is a view exemplarily illustrating an important portion of a second cooling surface of a second separator constituting the fuel cell stack according to an exemplary embodiment of the present disclosure, FIG. 5A, FIG. 5B, and FIG. 5C are views exemplarily illustrating a cross-section of a first reaction gas inflow region in the fuel cell stack according to an exemplary embodiment of the present disclosure, and FIG. 6 is a view exemplarily illustrating a cross-section of the first reaction gas inflow region in the fuel cell stack according to an exemplary embodiment of the present disclosure.

At the present time, FIG. 4 illustrates the second cooling surface of the second separator, but also illustrates the first separator overlapped with the drawing illustrating a stacked state with the first separator. Furthermore, FIG. 5A is a cross-sectional view of line A-A′ of FIG. 4, FIG. 5B is a cross-sectional view of line B-B′ of FIG. 4, and FIG. 5C is a cross-sectional view of line C-C′ of FIG. 4.

As illustrated in FIG. 5A, FIG. 5B, and FIG. 5C, the separator assembly for a fuel cell according to an exemplary embodiment of the present disclosure is formed by bonding a pair of separator 31 and separator 32, is stacked oppositely to face a sub-gasket 10′ surrounding and supporting the membrane-electrode assembly 10.

For example, the separator assembly for a fuel cell according to an exemplary embodiment of the present disclosure includes the first separator which is disposed to face the membrane-electrode assembly 10 and the sub-gasket 10′ on one side to form a first reaction gas, that is, a first reaction surface 31R through which hydrogen flows, and a first cooling surface 31C is cooled on the other side; a second separator 32 which is disposed to face the first cooling surface 31C of the first separator 31 and the second cooling surface 32C to be cooled on one side and a second reaction gas, that is, a second reaction surface 32R through which air flows, is formed on the other surface.

At the present time, a separate airtight line for airtightness is not formed on the first separator 31, and gasket lines 40C and 40R for airtightness are formed on the second cooling surface 32C and the second reaction surface 32R of the second separator 32 using a rubber gasket.

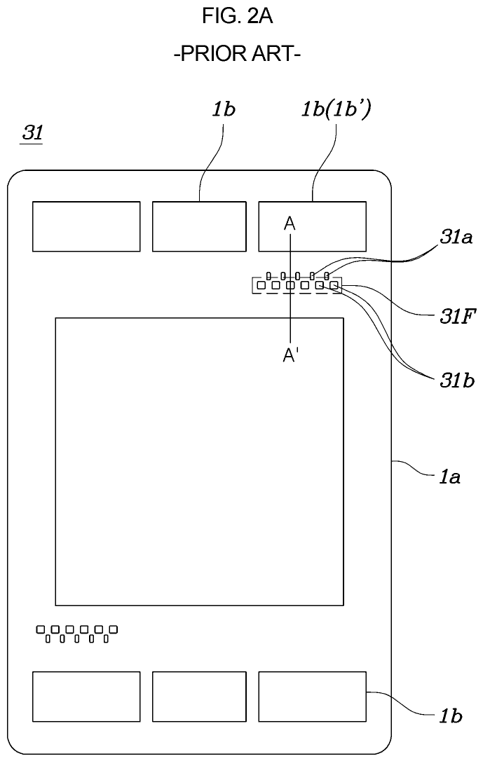

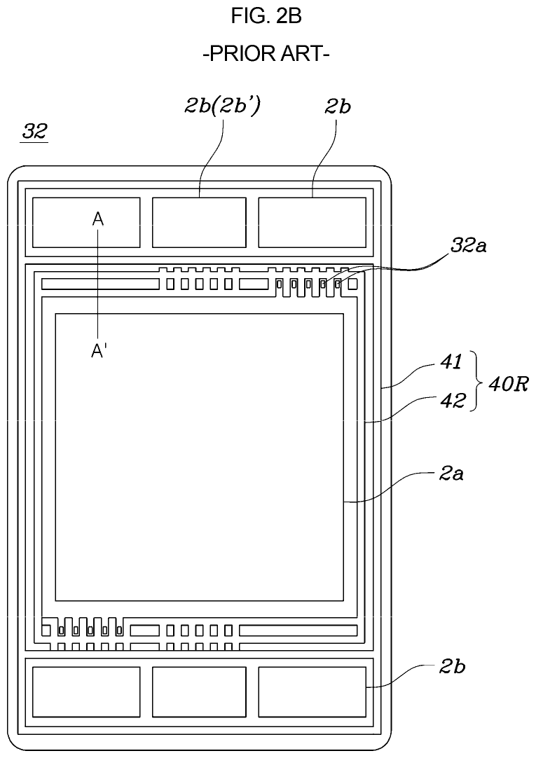

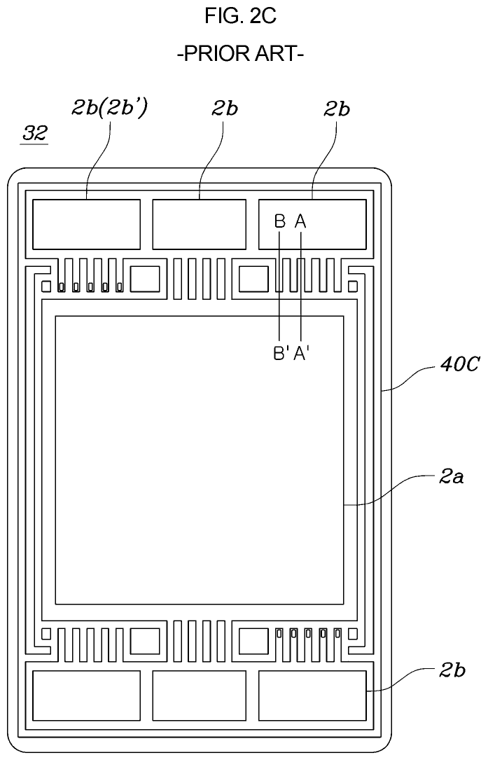

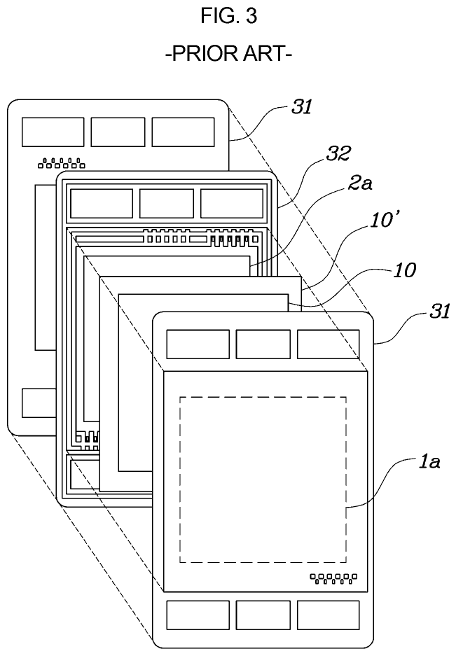

In an exemplary embodiment of the present disclosure, the first separator 31 and the second separator 32 maintain the configuration of an anode separator 31 and a cathode separator 32 illustrated in FIG. 2A, FIG. 2B and FIG. 2C.

Furthermore, a first reaction region 1a in which a flow path through which a first reaction gas flows is formed is formed in the central region of the first separator 31, and a plurality of manifolds 1b are formed in both sides of the first reaction region 1a. Any one of the plurality of manifolds 1b is the manifold 1b′ into which the first reaction gas is introduced.

A plurality of first reaction gas inflow flow paths 31a protruding and penetrating in a direction of the first reaction surface 31R are formed in a such manner that the first reaction gas introduced through a reaction gas inflow manifold 1b′ between the reaction gas inflow manifold 1b′ and a first reaction region 1a flows from the first cooling surface 31C into the first reaction region 1a through the first reaction surface 31R.

Furthermore, on the first separator 31, a plurality of support protrusions 31b are formed in a forming unit 31F formed at a predetermined interval to protrude from the first reaction gas inflow flow path 31a in the direction of the first reaction region 1a and protrude in the direction of the sub-gasket 10′.

At the present time, in the first separator 31, the first reaction gas inflow flow path 31a is spaced apart by a predetermined interval along a width direction of the first separator 31, and a plurality of first reaction gas inflow flow paths 31a are formed in parallel to the flow direction of the first reaction gas.

Furthermore, a plurality of support protrusions 31b are formed on a line parallel to a line in which the first reaction gas inflow flow path 31a is formed by being spaced apart along the width direction of the first separator 31.

Meanwhile, a gasket line 40R is formed for confidentiality between the first reaction surface 31R or the sub-gasket 10′ on the second reaction surface 32R of the second separator 32, and a gasket line 40C is formed for confidentiality between the first cooling surface 31C of the first separator 31 on the second cooling surface 32C.

In an exemplary embodiment of the present disclosure, the support protrusion 31b formed on the first separator 31 among the gasket line 40C and 40R formed on the second separator 32 improves a height and shape of the gasket lines 40C and 40R formed in the region corresponding to a distributed forming unit 31F.

In other words, as illustrated in FIG. 5A, FIG. 5B, and FIG. 5C, in an exemplary embodiment of the present disclosure, a reaction surface gasket line 40R formed on the second separator 32 is divided into a plurality of manifolds 2b, an external gasket line 41 in contact with the first separator 31 while surrounding the second reaction region 2a, and an internal gasket line 42 in contact with the sub-gasket 10′ while surrounding the second reaction region 2a. Furthermore, the internal gasket line 42 is further divided into a low region 42L formed in the region corresponding to the region where a forming unit 31F of the first separator 31 is formed, and a high region 42H formed in the region corresponding to the region where the forming unit 31F of the first separator 31 is not formed.

In the instant case, a height H_{L} of the low region 42L is lower than a height H_{H} of the high region 42H (H_{L}<H_{H}).

The reason for a difference in height between the low region 42L and the high region 42H is to consider a height of the support protrusion 31b protruding from the first separator 31.

Accordingly, the height H_{L} of the low region 42L is lower than the height Hu of the high region 42H by a height H_{P} of the support protrusion 31b (H_{L}+H_{P}=H_{H}).

As the low region 42L and the high region 42H are distinguished in the reaction surface gasket line 40R, one surface of the sub-gasket 10′ is in contact with the forming unit 31F of the first separator 31, and the other of the sub-gasket 10′ is in contact with the low region 42L of the reaction surface gasket line 40R, in the region corresponding to the region where the forming unit 31F of the first separator 31 is formed.

Furthermore, an edge region of the sub-gasket 10′ is bent by a height difference between the low region 42L and the high region 42H of the reaction surface gasket line 40R, so that one surface thereof is in contact with the first reaction surface 31R of the first separator 31 and the other surface thereof is in contact with the high region 42H of the reaction surface gasket line 40R. At the instant time, a section in which the sub-gasket 10′ is bent is formed at an external position of the region where the support protrusion 31b and the first reaction gas inflow flow path 31a are formed.

In the present way, as the reaction surface gasket line 40R is divided into the low region 42L and the high region 42H, and a height difference between the low region 42L and the high region 42H is formed by the height of the support protrusion 31b, the first separator 31 and the second separator 32 may maintain a constant distance. Accordingly, a uniform surface pressure may be formed in the entire region between the first separator 31 and the second separator 32 when a stack is stacked.

Furthermore, because the sub-gasket 10′ maintains a constant interval with the first separator 31 by the support protrusion 31b in the region except for the edge region, an inflow flow path of the first reaction gas flowing into the first separator 31 may be sufficiently secured.

Meanwhile, as illustrated in FIG. 6, in a region corresponding to the region where the forming unit 31F is formed among a cooling surface gasket line 40C formed on the second separator 32, a formation of the surface pressure is formed in the external region of the region where the support protrusion 31b of the first separator 31 is formed. Therefore, to maintain the surface pressure between the cooling surface gasket line 40C formed on the second separator 32 and the first separator 31, among the cooling surface gasket lines 40C formed in the second separator 32, a width W_{G} of a region corresponding to the region where the forming unit 31F is formed is wider than a width W_{P} of the support protrusion 31b (W_{G}>W_{P}).

Meanwhile, in the region corresponding to the region where the forming unit 31F is formed among the cooling surface gasket line 40C formed on the second separator 32, a shape of the cooling surface gasket line 40C may be changed to enhance a surface pressure when the surface pressure is formed.

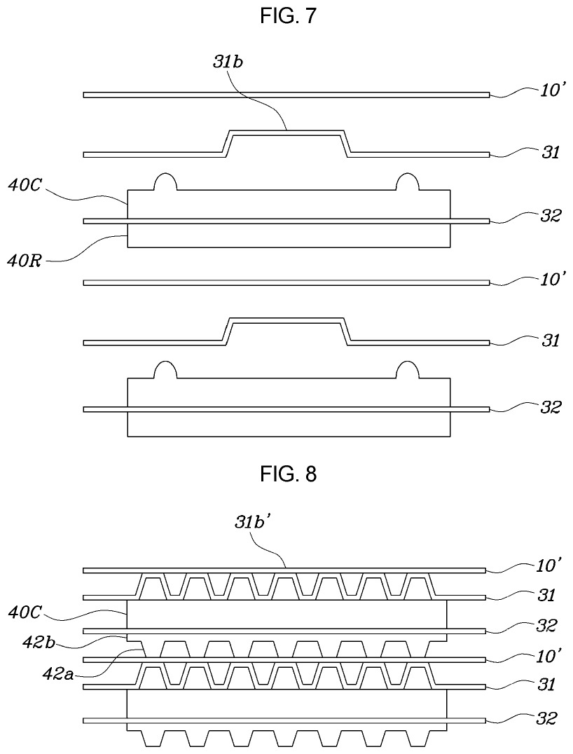

FIG. 7 is a view exemplarily illustrating a cross section of the first reaction gas inflow region in the fuel cell stack according to a modified embodiment of the present disclosure.

First, as illustrated in FIG. 7, a protrusion unit 43 protruding toward the first cooling surface 31C of the first separator 31 may be formed along an edge portion of the forming unit 31F where the support protrusion 31b is formed in the region where the forming unit 31F of the first separator 31 is formed among the cooling surface gasket line 40C formed on the second separator 32.

At the present time, a protrusion unit 43 is formed so that the support protrusion 31b is in contact with an unformed region in the forming unit 31F.

Furthermore, the protrusion unit 43 may be formed in a shape of line along a periphery of the support protrusion 31b in the forming unit 31F or may be formed in a shape of a dot at a predetermined interval.

In the present way, the protrusion unit 43 may be formed in a region where direct surface pressure is formed when a stack is stacked so that the cooling surface gasket line 40C may sufficiently maintain surface pressure in a region where surface pressure is concentrated.

Meanwhile, in the region corresponding to the region where the forming unit 31F is formed among the reaction surface gasket lines 40R formed on the second separator 32, a shape of the reaction surface gasket line 40R may be changed to enhance the surface pressure when the surface pressure is formed.

FIG. 8 is a view exemplarily illustrating a cross section of a first reaction gas inflow region in the fuel cell stack according to another modified example of the present disclosure.

As illustrated in FIG. 8, uneven units may be formed on the reaction surface gasket line 40R so that only a region in contact with the support protrusion 31b through the sub-gasket 10′ among the low regions 42L of the reaction surface gasket line 40R formed on the second separator 32 contacts with the sub-gasket 10′.

Among the low regions 42L of the reaction surface gasket lines 40R formed on the second separator 32, a region not in contact with the support protrusion 31b through the sub-gasket 10′ may be formed to have a height lower than the support protrusion 31b through the sub-gasket 10′.

Thus, the surface of the low region 42L of the reaction surface gasket line 40R formed on the second separator 32 may be formed in an uneven shape in which embossed units 42a and engraved units 42b are alternately formed.

At the present time, embossed units 42a of the low region 42L are formed in a region in contact with the support protrusion 31b through the sub-gasket 10′, and engraved units 42b of the low region 42L are formed in a region that does not contact with the support protrusion 31b through the sub-gasket 10′.

In the present way, when a stack is stacked, embossed units 42a are formed in the reaction surface gasket line 40R in the region where the forming unit 31F is formed, and engraved units 42b are formed in other regions to sufficiently maintain the surface pressure in a concentrated region of surface pressure, while the reaction surface gasket line 40R presses the sub-gasket 10′, and thus, the path through which the reaction gas flows may be prevented from being narrowed while being pushed into the space between the support protrusion 31b of the first separator 31.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain predetermined principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A separator assembly for a fuel cell, in which a pair of opposing separators are stacked with a sub-gasket surrounding and supporting a membrane-electrode assembly, the separator assembly comprising:
a first separator of the opposing separators, wherein the first separator includes:
a first reaction surface disposed to face the membrane-electrode assembly on a first side thereof and flowed with a first reaction gas;
a first cooling surface to be cooled in a second side thereof; and
a forming unit including a plurality of support protrusions formed at predetermined interval therebetween to protrude toward the sub-gasket; and
a second separator of the opposing separators, wherein the second separator includes:
a second cooling surface disposed on a first side thereof to face the first cooling surface of the first separator to be cooled;
a second reaction surface through which a second reaction gas flows in a second side thereof;
a reaction surface gasket line for airtightness of the first reaction surface or the sub-gasket of the first separator with the second reaction surface; and
a cooling surface gasket line forming an airtight line between the first cooling surface of the first separator and the second cooling surface,
wherein among reaction surface gasket lines formed in the second separator, a low region corresponding to a region where the forming unit of the first separator is formed is lower than a high region corresponding to a region where the forming unit is not formed.

2. The separator assembly of claim 1,
wherein a first surface of the sub-gasket is in contact with the forming unit of the first separator, and a second surface of the sub-gasket is in contact with the low region of the reaction surface gasket line, in the region where the forming unit of the first separator is formed.

3. The separator assembly of claim 1,
wherein an edge region of the sub-gasket is bent by a height difference between the low region and the high region of the reaction surface gasket line, so that a first surface of the sub-gasket is in contact with the first reaction surface of the first separator and a second surface of the sub-gasket is in contact with the high region of the reaction surface gasket.

4. The separator assembly of claim 1,
wherein among the reaction surface gasket lines formed in the second separator, a height of the low region is lower than a height of the high region by a height of the support protrusions.

5. The separator assembly of claim 1,
wherein among cooling surface gasket lines formed on the second separator, a width of the region where the forming unit is formed is wider than a width of the support protrusions.

6. The separator assembly of claim 1,
wherein among cooling surface gasket lines formed on the second separator, a protrusion unit protruding toward the first cooling surface of the first separator is formed along an edge portion of the forming unit formed with the support protrusions in the region where the forming unit is formed.

7. The separator assembly of claim 6,
wherein the protrusion unit is formed so that the support protrusions are in contact with an unformed region in the forming unit.

8. The separator assembly of claim 6,
wherein the protrusion unit is formed in a shape of line along a periphery of the support protrusions in the forming unit or is formed in a shape of a dot at a predetermined interval.

9. The separator assembly of claim 1,
wherein among low region of the reaction surface gasket lines formed in the second separator, only a region that contacts with the support protrusions through the sub-gasket is in contact with the sub-gasket.

10. The separator assembly of claim 9,
wherein among low region of the reaction surface gasket lines formed on the second separator, a region not in contact with the support protrusions through the sub-gasket is formed to have a height lower than the support protrusions through the sub-gasket.

11. The separator assembly of claim 9,
wherein a surface of the low region of the reaction surface gasket line formed on the second separator is formed in an uneven shape in which embossed units and engraved units are alternately formed, and
wherein the embossed units of the low region are formed in a region in contact with the support protrusions through the sub-gasket, and the engraved units of the low region are formed in a region that does not contact with the support protrusions through the sub-gasket.

12. The separator assembly of claim 1,
wherein a gasket line for confidentiality is not formed in the first reaction surface and the first cooling surface of the first separator.

13. The separator assembly of claim 1,
wherein the first reaction region which a flow path through which the first reaction gas flows is formed is formed in a central region of the first separator, a plurality of manifolds are formed in first and second regions of the first reaction region, and any one of the manifolds is a reaction gas inflow manifold which the first reaction gas flows, between the reaction gas inflow manifold and the first reaction region,
wherein a plurality of first reaction gas inflow flow paths protruding and penetrating in a direction of the first reaction surface are formed between the reaction gas inflow manifold and the first reaction region so that the first reaction gas introduced through the reaction gas inflow manifold flows from the first cooling surface to the first reaction surface, and
wherein the forming unit is formed to be spaced from the first reaction gas inflow flow paths by a predetermined interval in a first reaction region direction.

14. The separator assembly of claim 12,
wherein in the first separator, a plurality of first reaction gas inflow flow paths is spaced apart by a predetermined interval along a width direction of the first separator, and the plurality of first reaction gas inflow flow paths are formed in parallel in a flow direction and a vertical direction of the first reaction gas, and
wherein the plurality of support protrusions are spaced apart along the width direction of the first separator, and are formed on a line parallel to a line in which the first reaction gas inflow flow paths are formed.

15. A fuel cell stack, which is formed by stacking a sub-gasket surrounding and supporting a membrane-electrode assembly and a pair of gas diffusion layers, the fuel cell stack comprising:
a plurality of unit cells including a first separator and a second separator,
wherein the first separator and the second separator facing each other in adjacent unit cells are bonded and integrated,
wherein the first separator is disposed on a first surface thereof to face the membrane-electrode assembly to form a first reaction surface through which a first reaction gas flows, to form a first cooling surface to be cooled on a second surface thereof, and to form a forming unit in which a plurality of support protrusions are formed at predetermined intervals therebetween to protrude toward the sub-gasket,
wherein the second separator is disposed on a first surface thereof to face the first cooling surface of the first separator to form a second cooling surface, a second reaction surface through which a second reaction gas flows on a second surface thereof, and in the second reaction surface, a reaction surface gasket line for airtightness is formed between the second reaction surface and either of the first reaction surface or the sub-gasket of the first separator, and a cooling surface gasket line is formed on the second cooling surface to form an airtight line between the first cooling surface of the first separator and the second cooling surface, and
wherein among reaction surface gasket lines formed in the second separator, a low region corresponding to a region where the forming unit of the first separator is formed is lower than a high region corresponding to a region where the forming unit is not formed.

16. The fuel cell stack of claim 15,
wherein a first surface of the sub-gasket contacts with the forming unit in the region where the forming unit of the first separator is formed, and a second surface thereof contacts with the low region of the reaction surface gasket line.

17. The fuel cell stack of claim 15,
wherein the sub-gasket is bent by a height difference between the low region and the high region of the reaction surface gasket line in an edge region thereof, so that a first surface thereof contacts with the first reaction surface of the first separator and a second surface thereof contacts with the high region of the reaction surface gasket line.

18. The fuel cell stack of claim 15,
wherein a gasket line for confidentiality is not formed in the first reaction surface and the first cooling surface of the first separator.
